(19) United States
(12) Patent Application Publication
(10) Pub. No.: US 2009/0010116 A1
(43) Pub. Date: Jan. 8, 2009

(54) Information recording apparatus, information processing method, and computer program

(75) Inventor: Seigo Hanada, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 12/156,096

(22) Filed: May 29, 2008

(30) Foreign Application Priority Data
Jul. 6, 2007 (JP) P2007-177962

(51) Int. Cl. G11B 7/00

(52) U.S. Cl. 369/47.5

(57) ABSTRACT

In the present invention, there is provided an information recording apparatus for recording information to an optical disk including: a data recording section configured to record data while changing laser power levels successively; a data reproduction section; and an optimum recording power calculation section configured to calculate an optimum recording laser power level by evaluating the quality of a reproduced signal, wherein the data reproduction section performs data reproduction based on a PRML procedure, and based on PRML reproduction information, the optimum recording power calculation section finds an E error formed by the difference in a Euclidean distance squared between the most and second most likely path metric values in order to calculate E jitter values, the optimum recording power calculation section further calculating as the optimum recording power a laser power level corresponding to the recorded data of which the E jitter value is the smallest.

### CROSS REFERENCES TO RELATED APPLICATIONS

The present invention contains subject matter related to Japanese Patent Application JP 2007-177962 filed with the Japan Patent Office on Jul. 6, 2007, the entire contents of which being incorporated herein by reference.

### BACKGROUND OF THE INVENTION

1. Field of the Invention

The present invention relates to an information recording apparatus, an information processing method, and a computer program. More particularly, the invention relates to an information recording apparatus, an information processing method, and a computer program for recording information to optical disks at an optimum level of recording power through recording power control.

2. Description of the Related Art

Along with the galloping increase of information in general and the recent development of multimedia has come the widespread use of optical information storage media (i.e., optical disks) in the field of data storage. The optical disks have evolved illustratively into structures such as those utilizing blue laser to enhance storage density and capacity.

As the storage density on optical disks is increased, so are potential troubles: the Nyquist criteria are less likely to be met, the amplitude values of radio frequencies in MTF (modulation transfer function) tend to drop, and the sidelobe upon impulse response grows. These irregularities can result in a higher likelihood of intersymbol interference taking place, which makes it difficult to read signals accurately from the disk.

One probable cause of the intersymbol interference upon data reproduction is the thermal interference of marks having occurred during the recording of data by laser. An inappropriate level of recording power for laser output during recording apparently inflicts thermal interference on the mark pits formed on the optical disk. The thermal interference is considered to affect the shape of adjacent mark pits, resulting in the intersymbol interference during data reproduction.

To prevent the intersymbol interference due to thermal interference typically needs controlling the recording power for laser output at an appropriate level during the recording of data to the optical disk.

For typical optical disks, recording power is adjusted using the so-called OPC (Optimum Power Control) procedure. The procedure involves initially varying recording power with regard to a trial write area before actually recording data to the optical disk of interest.

The amplitude of RF waveforms from the trial write area is then referenced to calculate an optimum recording power level for recording power control.

The traditional OPC procedure for recording power control is known in three variations: β procedure, γ procedure, and κ procedure. These variations will be briefly discussed below.

### [β Procedure]

The β procedure is an OPC procedure mostly used in conjunction with write-once optical disks. The procedure involves obtaining an optimum level of recording power by taking advantage of the fact that the β value is changed by laser recording power during recording. The graphic representation in FIG. 1 shows how the β value behaves according to the β procedure, with the vertical axis denoting the RF amplitude values. The β value used with this procedure is defined as

β=(A1+A2)/(A1−A2)

The procedure is called the β procedure because the β value is used to acquire optimum recording power.

### [γ Procedure]

The γ procedure is an OPC procedure mostly used in conjunction with rewritable optical disks. The procedure involves obtaining an optimum level of recording power on the basis of the fact that the degree of modulation is changed by laser recording power during recording. The graphic representation in FIG. 2 shows how the γ value behaves according to the γ procedure, with the vertical axis denoting the RF amplitude. The degree of modulation “m” used by this procedure is a ratio of the peak-to-peak RF amplitude (IH) from the zero level, to the actual read amplitude (I) minus the DC level. That is, the value is defined as

m=I/IH

The above technique called the γ procedure utilizes the “m” value in acquiring optimum recording power.

[κ procedure]

The κ procedure is an OPC procedure mostly used in conjunction with BD-R/RE optical disks, a version of the Blu-ray laser disk. The procedure involves obtaining an optimum level of recording power based on the fact that the degree of modulation is changed by laser recording power during recording in the same manner as the above-described γ procedure. The κ procedure uses the same degree of modulation “m” as the γ procedure above. That is, the value is also defined as

m=I/IH

The above technique called the κ procedure also utilizes the “m” value in obtaining optimum recording power.

The above-described traditional OPC technology represented by the β, γ, and κ procedures references solely RF waveforms in calculating asymmetry and the degree of modulation for the purpose of controlling the optimum level of recording power. However, next-generation optical disks of high recording density and large capacity tend to suffer from numerous bit errors due to intersymbol interference. The traditional procedures for referencing RF waveforms alone are not sufficient for dealing with such bit errors attributable to intersymbol interference. That is, the ordinary OPC technology is no longer sufficient for controlling optimum recording power. Another problem is that the ordinary OPC was not designed with the PRML (Partial Response Maximum Likelihood) technology for high-density, mass-storage next-generation optical disks in mind. Hence the insufficient capability of the OPC to control optimum recording power during PRML data reproduction.

The typical setup of reproducing data from ordinary optical disks uses a binary (i.e., “1” or “0”) slice level by which to determine whether a signal exceeding a predetermined slice level has been read. In that reproduction setup, the TIA Jitter (Time Interval Analyzer Jitter) value and the bit error rate conform theoretically to each other. On the other hand, the majority of next-generation optical disk systems featuring high density and large capacity utilize the PRML technology instead of the binary slice level. The TIA Jitter value derived from the ordinary binary slice signal detection has no conformity to the theory of data reproduction of the new-generation systems. This poses the problem of accuracy in terms of evaluation values.

### SUMMARY OF THE INVENTION

The present invention has been made in view of the above circumstances and provides an information recording apparatus, an information processing method, and a computer program for recording data to optical disks at an optimum level of recording power through recording power control.

More particularly, the invention provides an information recording apparatus, an information processing method, and a computer program for recording data to high-density optical disks compatible with the systems of PRML (Partial Response Maximum Likelihood) reproduction, the data being recorded with high quality at an optimum level of recording power through recording power control.

In carrying out the present invention and according to one embodiment thereof, there is provided an information recording apparatus for recording information to an optical disk, the information recording apparatus including: a data recording section configured to record data to the optical disk while changing laser power levels successively; a data reproduction section configured to reproduce the data recorded by the data recording section; and an optimum recording power calculation section configured to calculate an optimum recording laser power level by evaluating the quality of a reproduced signal created by the data reproduction section. In the information recording apparatus, the data reproduction section performs data reproduction based on a partial response maximum likelihood procedure known as PRML, and, based on PRML reproduction information created by the data reproduction section, the optimum recording power calculation section finds an E error formed by the difference in a Euclidean distance squared between the most likely path metric value and the second most likely path metric value in order to calculate E jitter values representing deviations of the E error from a theoretical value E₀ of E error distribution, the optimum recording power calculation section further calculating as the optimum recording power a laser power level corresponding to the recorded data of which the E jitter value is the smallest.

According to another embodiment of the present invention, there is provided an information processing method for causing an information recording apparatus which records information to an optical disk to calculate optimum recording power, the information processing method including the steps of: recording data to the optical disk while changing laser power levels successively; reproducing the data recorded in the data recording step; and calculating an optimum recording laser power level by evaluating the quality of a reproduced signal created in the data reproducing step. In the information processing method, the data reproducing step performs data reproduction based on a partial response maximum likelihood procedure known as PRML, and, based on PRML reproduction information created in the data reproducing step, the optimum recording power calculating step finds an E error formed by the difference in a Euclidean distance squared between the most likely path metric value and the second most likely path metric value in order to calculate E jitter values representing deviations of the E error from a theoretical value E₀ of E error distribution, the optimum recording power calculating step further calculating as the optimum recording power a laser power level corresponding to the recorded data of which the E jitter value is the smallest.

According to a further embodiment of the present invention, there is provided a computer program for causing an information recording apparatus which records information to an optical disk to calculate optimum recording power, the computer program including the steps of: recording data to the optical disk while changing laser power levels successively; reproducing the data recorded in the data recording step; and calculating an optimum recording laser power level by evaluating the quality of a reproduced signal created in the data reproducing step. In the computer program, the data reproducing step performs data reproduction based on a partial response maximum likelihood procedure known as PRML, and, based on PRML reproduction information created in the data reproducing step, the optimum recording power calculating step finds an E error formed by the difference in a Euclidean distance squared between the most likely path metric value and the second most likely path metric value in order to calculate E jitter values representing deviations of the E error from a theoretical value E₀ of E error distribution, the optimum recording power calculating step further calculating as the optimum recording power a laser power level corresponding to the recorded data of which the E jitter value is the smallest.

Where the present invention is embodied as outlined above, PRML (Partial Response Maximum Likelihood) reproduction is made of data having been recorded with the level of laser power changed successively. Based on PRML reproduction information created by the reproduction, an E error is found which is constituted by the difference in a Euclidean distance squared between the most likely path metric value and the second most likely path metric value in order to calculate E jitter values representing deviations of the E error from a theoretical value E₀ of E error distribution. Then optimum recording power is calculated in the form of a laser power level corresponding to the recorded data of which the E jitter value is the smallest. The invention thus makes it possible to determine the optimum recording power for acquiring the reproduced signal with a minimum of errors in compliance with the principle of PRML reproduction.

The computer program of an embodiment according to the present invention may be offered in computer-readable form using suitable storage or communication media for execution by general-purpose computer systems capable of executing diverse program codes. The processes constituted by the computer program are implemented when the program is read and carried out by the computer system.

### BRIEF DESCRIPTION OF THE DRAWINGS

These and other objects of the invention will be seen by reference to description, taken in connection with the accompanying drawings, in which:

FIG. 1 is a schematic view explanatory of the β procedure as a recording power control process of the ordinary OPC (Optimum Power Control) technology;

FIG. 2 is a schematic view explanatory of the γ procedure as another recording power control process of the ordinary OPC technology;

FIG. 3 is a schematic view explanatory of a filtering process in PRML reproduction;

FIG. 4 is a schematic view explanatory of state transitions in PRML reproduction;

FIG. 5 is a schematic view explanatory of a trellis diagram showing state transitions in PRML reproduction;

FIGS. 6A and 6B are trellis diagrams showing state transitions in PRML reproduction, and a schematic view explanatory of an E error;

FIGS. 7A and 7B are schematic views explanatory of jitter values calculated from the E error in PRML reproduction;

FIG. 8 is a flowchart of steps constituting an optimum recording power setting sequence as an embodiment of the present invention;

FIG. 9 is a block diagram showing a typical structure of an information recording apparatus as the embodiment of the present invention;

FIGS. 10A, 10B and 10C are schematic views explanatory of how recording power sweep is carried out;

FIG. 11 is a schematic view explanatory of how the recording power level at which the E jitter value (EJitter or EJitter₀) is the smallest is set as the optimum recording power;

FIG. 12 is a flowchart of steps constituting the optimum recording power setting sequence as another embodiment of the present invention;

FIG. 13 is a flowchart of steps constituting the optimum recording power setting sequence as further another embodiment of the present invention; and

FIG. 14 is a flowchart of steps constituting the optimum recording power setting sequence as further another embodiment of the present invention.

### DETAILED DESCRIPTION OF THE PREFERRED EMBODIMENTS

An information recording apparatus, an information processing method, and a computer program practiced as preferred embodiments of the present invention will now be described below in reference to the accompanying drawings.

The information recording apparatus of an embodiment according to the present invention is an apparatus that records data to an optical disk while controlling the level of recording power at an optimum level. In particular, the inventive information recording apparatus is capable of effecting optimum recording power control when recording data to a high-density optical disk compatible with the PRML (Partial Response Maximum Likelihood) reproduction system.

Outlined below is how data is typically recorded to the optical disk. The recording of data to the optical disk is carried out by focusing a laser beam onto the recording surface of the disk and thereby changing the surface state of the disk. For example, on a write-once optical disk, the focused laser beam heats the recording film (organic coloring mater, inorganic material) of the disk and causes a thermal change and a refractive index variation of the film. On a rewritable optical disk, the focused laser beam heats the recording film (phase change material) and changes its phase. Upon reproduction, the changes in the reflection factor of the phase-changed recording film are detected.

To eliminate errors in reading information generally needs applying the laser beam to the recording film of the optical disk at an optimum level of laser recording power. If the level of laser recording power is inappropriate, intersymbol interference can result from the thermal interference taking place during the formation of recording marks. In addition to the laser recording power, what is known as the write strategy (i.e., chronological laser generation pattern) can also affect the occurrence of intersymbol interference. Recording disks are usually furnished with recommended recording power information that has been set by each manufacturer of the media (i.e., optical disks). However, the recommended power information rarely conforms to an optical recording power specific to the disk in question. The absence of the conformity is attributable to heat sensitivity irregularities of the recording film of the disk or to an outright lack of credibility of the furnished information. For these reasons, it is preferable suitably to control the recording power for recording data so that high-quality data, i.e., data from which to obtain high-quality reproduced signals, may be recorded to the optical disk.

The control of optimum recording power by the information recording apparatus embodying the present invention is based not on the evaluation values derived from the RF amplitude but on what is known as the E value acquired through a PRML (Partial Response Maximum Likelihood) procedure. The E value will be discussed later in detail. Using the E value as the evaluation value for the control of optimum recording power makes it possible to calibrate an optimum level of recording power suitable for high-density, mass-storage next-generation optical disks. With the PRML technology assumed to be in use for the next-general optical disks, the inventive information recording apparatus precisely controls the level of optimum recording power during PRML reproduction.

Prior to an explanation of the recording power control by the information recording apparatus of this invention, two techniques utilized by systems for recording and reproducing data to and from an optical disk at high density are outlined below. These techniques are:

(a) RLL (Run Length Limited) code; and

(b) PRML (Partial Response Maximum Likelihood) reproduction.

### (a) RLL (Run Length Limited) Code

The continuous increase in the recording capacity of optical disks has been accompanied by the matching rise in their recording density. Given the recording density increase, it has become increasingly difficult to meet the Nyquist criteria, which makes it ever more likely to trigger intersymbol interference. The RLL (Run Length Limited) code is intended to suppress intersymbol interference by extending edge intervals while boosting recording density. The RLL code is one form of run-length encoding. More specifically, when m-bit data to be recorded is converted into n-bit data (“m” and “n” are different) for run-length encoding, the maximum and the minimum run lengths of the data are limited.

The minimum reverse interval (Tmin) in the RLL code is defined as

Tmin=(d+1)(m/n)Td

where, Td stands for the clock width; “d” denotes the maximum number of continuous 0's in an NRZI (Non Return to Zero Inverted) signal, a recording signal generated by inverting the polarities of a pulse depending on 0's or 1's occurring in the modulated data to be recorded; and (d+1) represents the shortest run length. The notation “Tmin/Td” denotes recording density ratio, the value of which is preferably longer under optical constraints.

The maximum reverse interval (Tₘₐₓ) of the RLL code is defined as

Tmax=(k+1)(m/n)Td

where, “Td” stands for the clock width; “k” denotes the maximum number of continuous 0's in an NRZI (Non Return to Zero Inverted) signal; and (k+1) represents the maximum run length. The value “Tmax/Td” is preferred to be shorter in view of the stability in clock generation.

The detection window width (Tw) is defined as

Tw=(m/n)Td

The width Tw is preferred to be larger for higher tolerance of jitters. The larger the detection window width Tw, the easier it is to read reproduced signals. The narrower the detection window width Tw, the higher the accuracy necessary for reading the signals.

### (b) PRML Reproduction

The process of PRML (Partial Response Maximum Likelihood) reproduction will now be outlined. The use of the above-described RLL code helps boost recording density by minimizing intersymbol interference. However, complete elimination of intersymbol interference is difficult to achieve because of various other factors (e.g., optical and mechanical factors). This is where the technique called PRML comes in, a technique whereby a certain level of intersymbol interference is predicted to occur so that the interference may be stochastically removed in the subsequent process of reproduction.

The PRML technique involves setting up partial response transmission paths as the transmission channel for tolerating a certain level of intersymbol interference. The partial response procedure is a technique that puts the reproduced signal into multiple levels by tolerating (i.e. predicting) a certain level of intersymbol interference. When combined with the most likelihood reproduction procedure, this technique enhances recording density while minimizing errors in data determination.

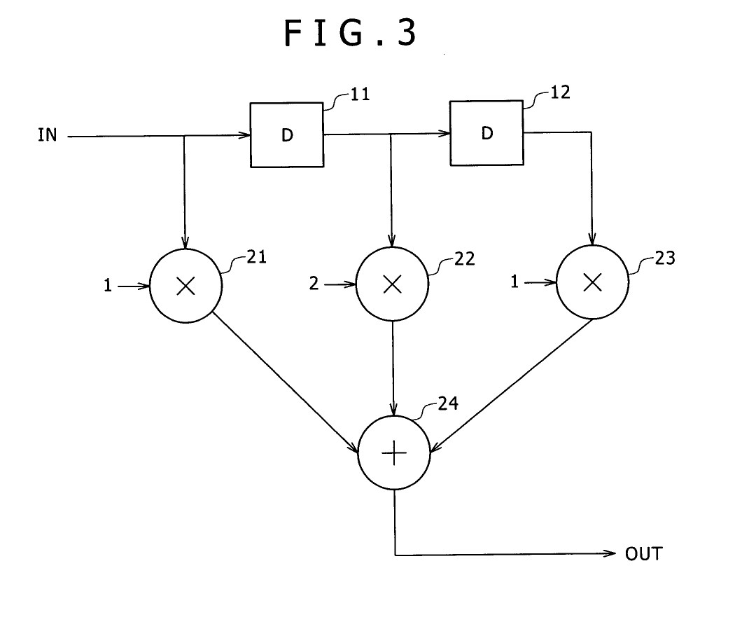

What follows is an explanation of the PRML procedure that utilizes a PR (partial response) class [PR(1, 2, 1)]. The partial response transmission channel may be regarded as a virtual FIR (Finite Impulse Response) filter that has a predetermined tap coefficient. An example of this filter is shown structurally in FIG. 3.

FIG. 3 illustrates an example of the PRML filter that uses the partial response class [PR(1, 2, 1)]. In the filter of FIG. 3, an input value (IN) is arranged to enter delay circuits 11 and 12 to generate a non-delayed signal, a one-bit delayed signal and a two-bit delayed signal which are fed respectively to coefficient multipliers 21 through 23. The multipliers 21 through 23 multiply the signals by coefficients 1, 2 and 1 respectively, before sending their products to an adder 24 that outputs the sum. For the filter of FIG. 3, the input is either 0 or 1 and the output is any one of integers 0 through 4.

The filter in FIG. 3 includes four states (Snm=S00, S01, S11, S10). The value “n” in Snm denotes the value 0 or 1 to be input to the coefficient multiplier 22 of the filter in FIG. 3, and the value “m” in Snm represents the value 0 or 1 to be input to the coefficient multiplier 23.

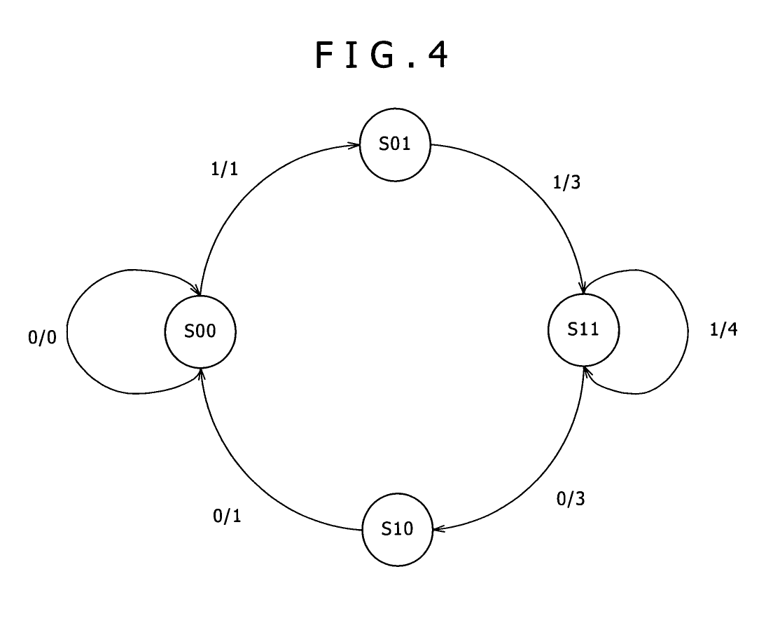

FIG. 4 is a state transition diagram involving four states (Snm=S00, S01, S81, S10). The transitions between these states are determined by the input and output to and from the filter shown in FIG. 3. Illustratively, if the current state is S00 in the state transition diagram of FIG. 4 and if the filter input is 0 and the filter output is 0 (i.e., 0/0), then the state S00 is followed by the state S00. If the current state is S00 and if the filter input is 1 and the filter output is 1 (i.e., 1/1), then the state S00 is followed by the state S01.

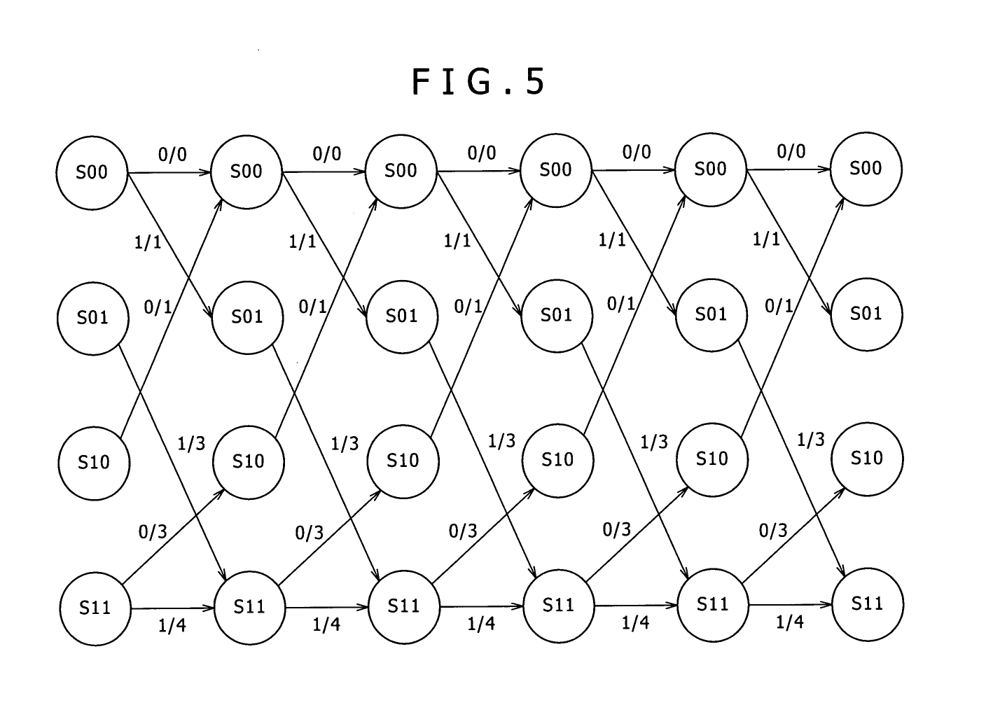

FIG. 5 is a trellis diagram representing chronologically the state transitions shown in the diagram of FIG. 4, with the passage of time assumed to be in the rightward direction in FIG. 5. In FIG. 5, the line segments connecting the states (S00 through S11) are denoted by numbers 0/0, 1/1, 0/1, 1/3, 0/3, and 1/4 indicative of the input and output signals to and from the filter shown in FIG. 3.

The difference squared between an input and an output signal is called a branch metric value. The accumulation of branch metric values of a given state up to the current time is called a path metric value. Illustratively, with different states in effect at a given time “t,” the path metric value of each state up to time “t−1” and the branch metric value corresponding to each state transition are added up to give a sum. In this case, the state transition (i.e., path) that brings about the smallest sum is selected as the most likely path.

The PRML reproduction procedure involves reading signals from the disk as the signals to be input to the filter of FIG. 3 and identifying the readout signals by selecting the most likely state transition (i.e., most likely path) from the trellis diagram shown in FIG. 5. This procedure utilizes what is known as Viterbi decoding. The Viterbi decoding technique involves repeating the simple processes of addition, comparison and selection and implementing the most likely decoding of convolutional codes through trace-back operations for the ultimate decoding of data. With Viterbi decoding in effect, every time coded data (incoming data series) corresponding to one bit of information is obtained, the signal-to-signal distance (i.e., metric value) is calculated of the paths between the states involved at that point in time, so that the most likely path is obtained.

### (Explanation of E Error)

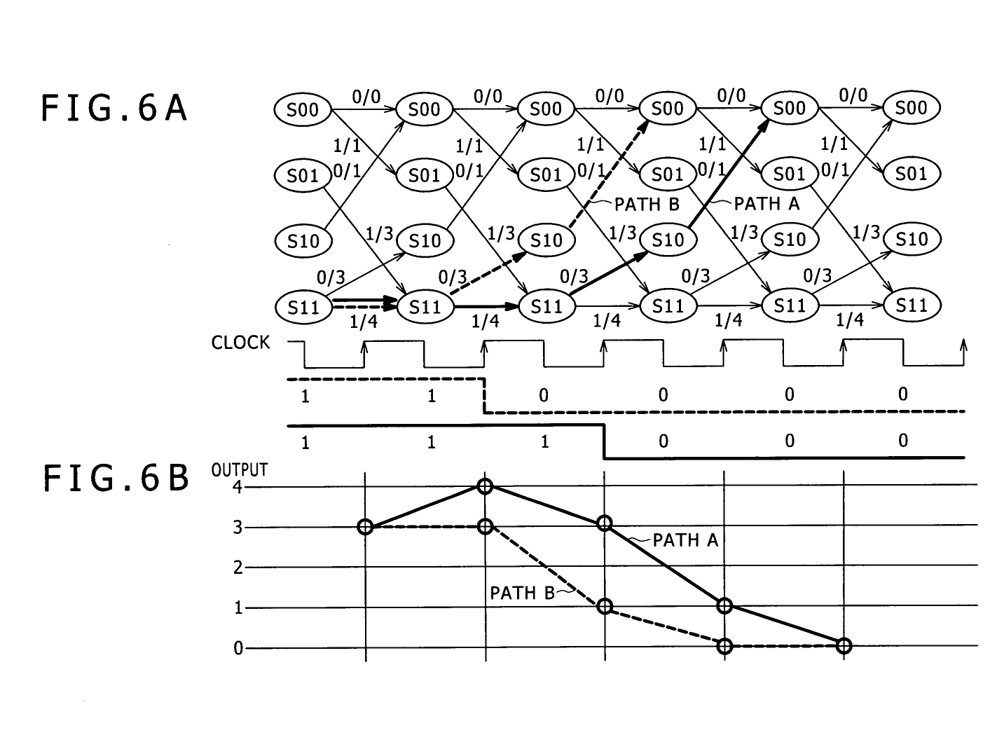

When the most likely path is to be acquired, the so-called E error is calculated. Suppose that two paths A and B that are similar to each other in likelihood exist as illustrated in FIG. 6A. In this case, the output from the two paths turns out to constitute different data as shown in FIG. 6B. The E error is obtained when the most likely of the two path is to be selected.

The E error is the sum of the differences in the Euclidean distance squared between the most likely path metric value and the second most likely path metric value. The E error is defined by the expression (1) below:

$$E = {\sum }_{k} {( {z}_{k} - {P}_{k} )}^{2} - {\sum }_{k} {( {z}_{k} - {S}_{k} )}^{2} \qquad ( 1 )$$

where, “zₖ” stands for a reproduced signal value, “Pₖ” for the second most likely path metric value, and “Sₖ” for the most likely path metric value.

The value of the E error calculated using the expression (1) above serves as an index of the degree of error in the reproduced signal. Depending on the PR class, E error values form a normal pattern of distribution around a theoretical value. A path error constitutes an edge shift that serves as an index strongly related to bit error rate. If the path error value is zero, that means the reproduced signal value is in the middle position between the most likely path and the second most likely path. This is a state in which a bit error is likely to occur. If the path error value is a negative value, that means a path error has occurred. This is a state in which a bit error has taken place.

If the theoretical value of distribution derived from the PR class is E₀, then what is obtained is an E jitter value representing the deviation of the E error from the theoretical value E₀ of distribution. The E jitter value is calculated by the following expression (2):

$$EJitter = \frac{1}{2 {E}_{0}} \sqrt{\frac{1}{n} \sum {E}^{2} - {( \frac{1}{n} \sum E )}^{2}} \times 100 [ \% ] \qquad ( 2 )$$

The E jitter value calculated by use of the expression (2) above is related to the degree of intersymbol interference caused by thermal interference during mark formation based on the recording of data to the disk. As such, the E jitter value can be used to adjust recording power. The proportion of E values deviating from the theoretical value E₀ serving as the reference over twice the interval in question is considered jitters.

The theoretical value E₀ from which the E value deviates is obtained upon selection of the PR class. The deviations in differences from the theoretical value may also be regarded as jitters. That is, the value (EJitter₀) is obtained using the deviations of differences derived from the expression (3) below:

$${EJitter}_{0} = \frac{1}{2 {E}_{0}} \sqrt{\frac{1}{n} \sum {( E - {E}_{0} )}^{2} - {[ \frac{1}{n} \sum ( E - {E}_{0} ) ]}^{2} \times 100 [ \% ]} \qquad ( 3 )$$

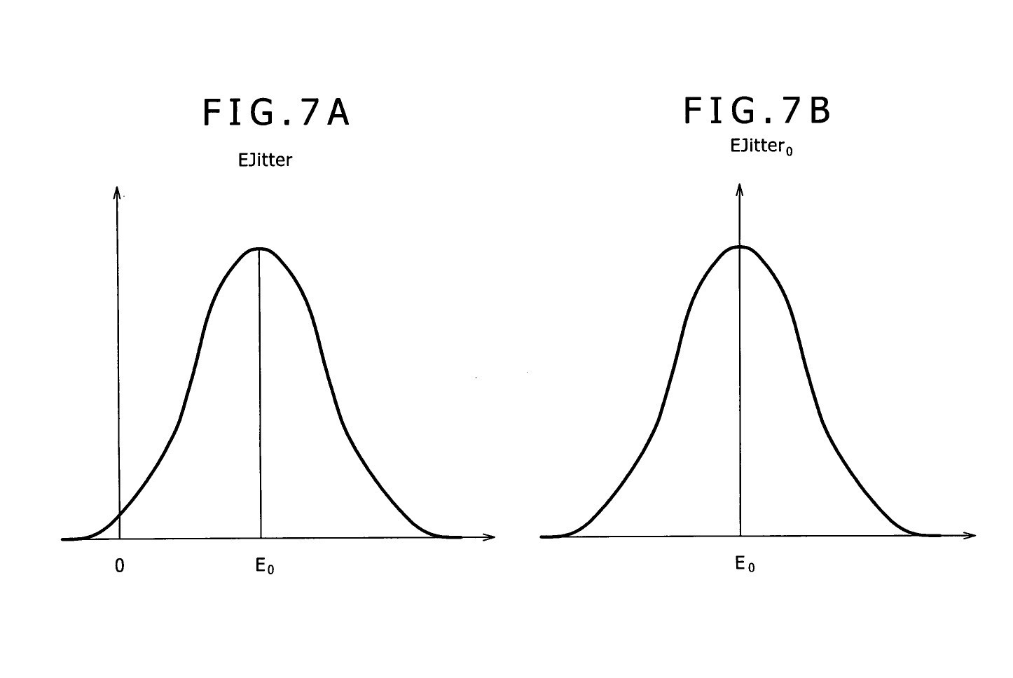

FIGS. 7A and 7B show how the E jitter value (EJitter) calculated by the expression (2) above and the E jitter value (EJitter₀) computed by the expression (3) above are typically distributed. The distribution of the jitter values obtained by the expression (2) and the distribution of the jitter values acquired by the expression (3) each correspond to what is obtained by having their central axis shifted.

[Optimum recording power Setting Sequence Using PRML according to the Invention]

### First Embodiment

Described below is an optimum recording power setting sequence using PRML and practiced as an embodiment of the present invention.

The PRML-based optimum recording power setting sequence according to the embodiment of the present invention is arranged to calibrate recording power by utilizing not the evaluation value derived from the RF amplitude but the evaluation value EJitter (or EJitter₀) using PRML as the index of evaluation for execution of recording power control.

That is, the level of recording power is controlled in such a manner as to minimize the evaluation value EJitter (or EJitter₀) using PRML. For example, when recording power is to be calibrated, the media information (DI: disk information) offered by the media vendor is referenced. The recording power is then changed to different levels in reference to the recording power level furnished as the media information (the process is called recording power sweep). Evaluation values for the different recording power levels are then measured, and an optimum recording power level is calculated accordingly.

More specifically, the information recording apparatus embodying the present invention records data to the optical disk of interest while changing the power level of laser successively, and performs PRML (Partial Response Maximum Likelihood) reproduction of the data thus recorded. Based on information derived from the PRML reproduction, the apparatus finds the E error (defined by the expression (1) above) formed by the difference in a Euclidean distance squared between the most likely path metric value and the second most likely path metric value. The apparatus then calculates the E jitter value (EJitter or EJitter₀) as the evaluation value defined by the expression (2) or (3) above, i.e., the value representing the deviation of the E error from the theoretical value E₀ of E error distribution. The apparatus proceeds to calculate as optimum recording power a laser power level corresponding to the recorded data of which the E jitter value thus calculated is the smallest.

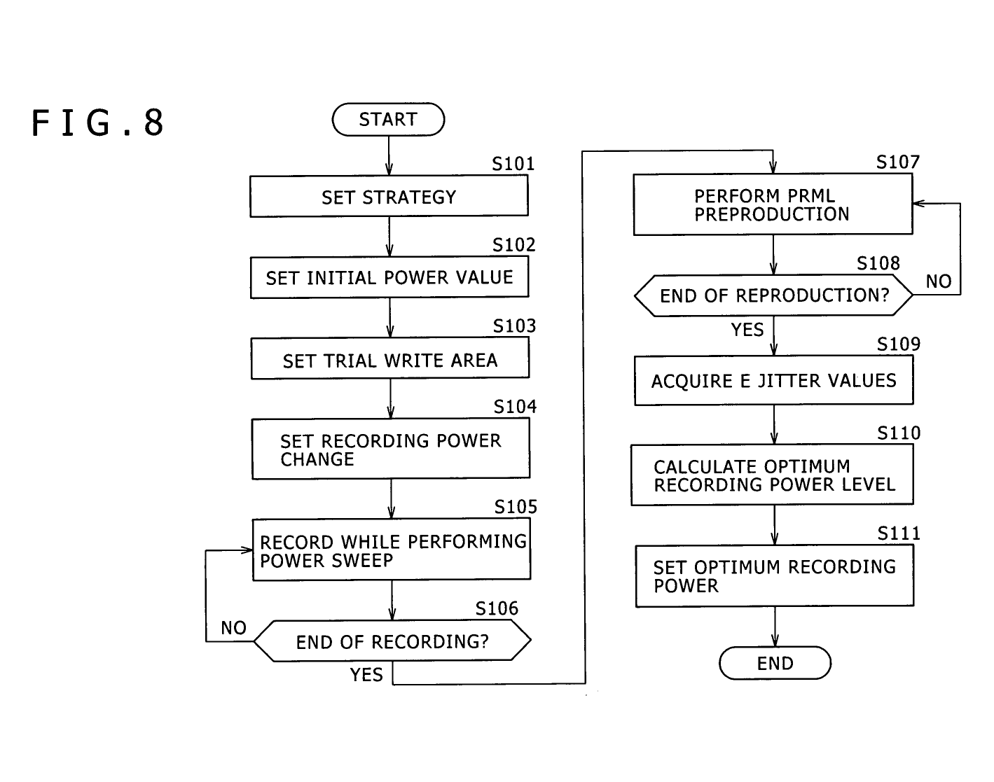

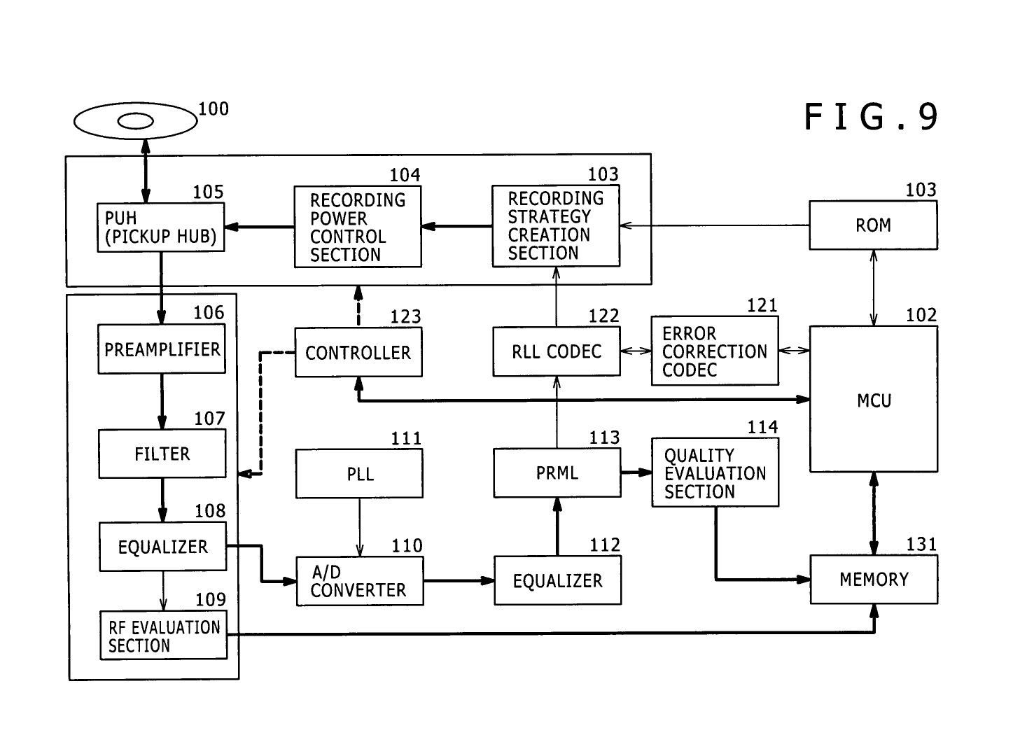

FIG. 8 is a flowchart of steps constituting an optimum recording power setting sequence as an embodiment of the present invention. FIG. 9 is a block diagram showing a typical structure of an information recording apparatus also embodying the present invention. The information recording apparatus of FIG. 9 carries out the sequence made up of the steps shown in the flowchart of FIG. 8. Each of the steps in FIG. 8 will be discussed below in detail with reference to the block diagram of FIG. 9.

In step S101, a strategy is set. This is the step of setting an appropriate recording strategy in accordance with the type of the disk to which to record data with a view to establishing an optimum recording power level. In the block diagram of FIG. 9, overall control is effected by a machine control unit (MCU) 102. The MCU 102 reads programs and parameters from a memory 131 or a ROM 103 to carry out illustratively the sequence constituted by the steps in FIG. 8. The strategy setting process of step S101 is performed by a recording strategy creation section 103 shown in FIG. 9. Strategy information reflecting different disk types is held illustratively in the ROM 103. The recording strategy creation section 103 selects the recording strategy corresponding to the type of a disk 100 to be used.

In step S102, an initial recording power level is set. This step is carried out by a recording power control section 104 shown in FIG. 9. The recording power control section 104 acquires recording power information constituting an initial value from the disk information (DI: disk information) offered by the manufacturer of the disk 100. The information thus acquired denotes the recording power level recommended by the media manufacturer and can serve as an initial value for recording power sweep. If such disk information is not available, then default information set on the system may be utilized as the initial recording power level.

In step S103, a trial write area is set. This is the step of setting on the disk 100 the trial write area used to implement the function of calibrating the optimum recording power level. Normally, recording media have the trial write area prepared thereon. Because data cannot be erased from write-once optical disks, this type of disks needs to be checked for an area that may serve as the trial write area. On rewritable optical disks, the trial write area may have been used up already. In that case, the existing data needs to be deleted from the trial write area. Data may be set to be written to the trial write area in increments of the data to be processed. For example, data may be written to the CD in increments of frames, to the DVD in ECC blocks, and to the BD in clusters (RUB).

In step S104, recording power levels are set to be changed. This step is carried out by the recording power control section 104 in FIG. 9. A trial write operation is started at the initial recording power level and continued while the recording power level is changed successively. The recording power level is changed in increments of write data blocks in the optical disk format. Illustratively, the recording power level is changed for the CD-R/RW in increments of sectors. The recording power level is changed in increments of sectors for the DVD-R/RW and DVD+R/RW which are then used in increments of ECC blocks. The recording power level is changed in increments of sectors for the BD-R/RE that is then used in increments of RUB blocks. The number of times the recording power is changed is determined by the trial write area and by the data increments for the recording power change. Data write and read operations are carried out under control of the MCU 102 and a controller 123.

In step S105, data is recorded while the recording power level is changed successively in a previously timed manner. This step constitutes what is known as recording power sweep. The recording of data is performed during the process of recording power sweep.

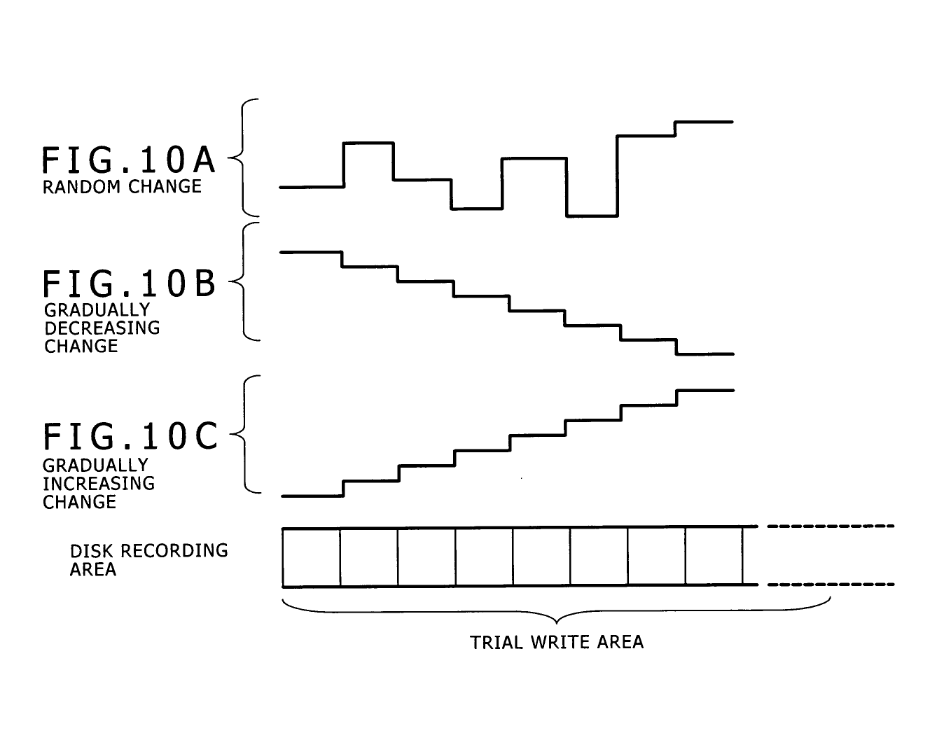

FIGS. 10A, 10B and 10C are schematic views explanatory of how recording power sweep is carried out.

When the recording power level is changed for a sweep, the change may be effected illustratively in one of three ways:

(a) The laser recording power is changed in random fashion;

(b) The laser recording power is changed in gradually decreasing fashion; or

(c) The laser recording power is changed in gradually increasing fashion.

One of the three methods above may be used to record data.

Furthermore, one of the recording pattern usages outlined below may be adopted for the recording of data with the power level changed:

[a] Random data may be used as the data to be recorded. In this case, data patterns are not definitely determined. The recording patterns to be adopted include the nT pattern under the corresponding RLL code rules.

[b] Data patterns may be designated as the data to be recorded. In this case, any desired data pattern may be designated. On a high-density recording optical disk, bit errors attributable to the edge shift over short marks tend to grow. For that reason, using only the short marks as the data to be recorded permits efficient evaluation. For example, on the BD, the data patterns are designated in such a manner that the shortest mark “2T” is used as the data to be recorded. Other data patterns that can be designated include all zero-cross edge patterns, positive edge patterns, negative edge patterns, 2 to 5 mark edge 2 to 5 space edge patterns, and 2 to 5 space edge 2 to 5 mark edge patterns.

In step S106, a check is made to determine if the recording has ended. If the end of the recording is verified, then step S107 is reached. In step S107, the PRML reproduction process is carried out in the manner described above. In this process, a signal read through a pickup hub (PUH) 105 shown in the block diagram of FIG. 9 is forwarded through a preamplifier 106, a filter 107 and an equalizer 108 to reach an A/D converter 110 and an equalizer 112 for analog-to-digital conversion. The data in digital form is then input to a PRML block 113 that acquires a reproduced signal through PRML signal processing. The reproduced signal is output to a quality evaluation section 114 shown in FIG. 9. In the normal reproduction process, the reproduced signal from the PRML block 113 is sent to an RLL codec 122 and an error correction codec 121 for codec processing.

In step S108, a check is made to determine if the reproduction has ended. If the end of the reproduction is verified, then step S109 is reached. In step S109, the quality evaluation section 114 acquires E jitter values (EJitter or EJitter₀). Obtained in this step are the E jitter values (EJitter or EJitter₀) in increments of data recorded with the recording power level changed. The acquired E jitter values are stored into the memory 131.

The E jitter values (EJitter or EJitter₀) may be obtained in one of two ways outlined below:

[a] E jitter values (EJitter or EJitter₀) may be acquired for all patterns. In this method, E jitter values (EJitter or EJitter₀) are measured in increments of data recorded with the recording power level changed regardless of forward or backward edge patterns.

[b] E jitter values (EJitter or EJitter₀) may be obtained after specific patterns are designated. In this method, E jitter values (EJitter or EJitter₀) are measured in increments of data recorded with the recording power level changed and with the forward and backward edge patterns designated. On a high-density recording optical disk, bit errors due to the edge shift over short marks tend to increase. For that reason, only the short marks are subjected to pattern matching for evaluation. On the Blu-ray Disk (BD), for example, E jitter values (EJitter or EJitter₀) attributable to the edge shift over the short marks (2T, etc.) are measured.

The foregoing process is carried out by the quality evaluation section 114 shown in the block diagram of FIG. 9. The quality evaluation section 114 can obtain the E error by use of the expression (1) explained above. The acquired E error is stored into the memory 131. The quality evaluation section 114 also calculates the E jitter values (EJitter or EJitter₀) corresponding to different recording power levels through the use of the expression (2) or (3) described above. The calculated E jitter values (EJitter or EJitter₀) are also stored into the memory 131.

In step S110, an optimum recording power level is calculated. In this step, the optimum recording power level is computed by referencing the E jitter values (EJitter or EJitter₀) corresponding to the diverse recording power levels that have been acquired.

The process of step S110 is carried out by the MCU (machine control unit) 102 shown in the block diagram of FIG. 9. The MCU 102 calculates the optimum recording power level by referring to the E jitter values (EJitter or EJitter₀) corresponding to the different recording power levels and stored in the memory 131. The E jitter values (EJitter or EJitter₀) are related numerically to intersymbol interference and associated with bit error rates. It follows that the E jitter values (EJitter or EJitter₀) stemming from the data recording at the optimum recording power level are relatively small.

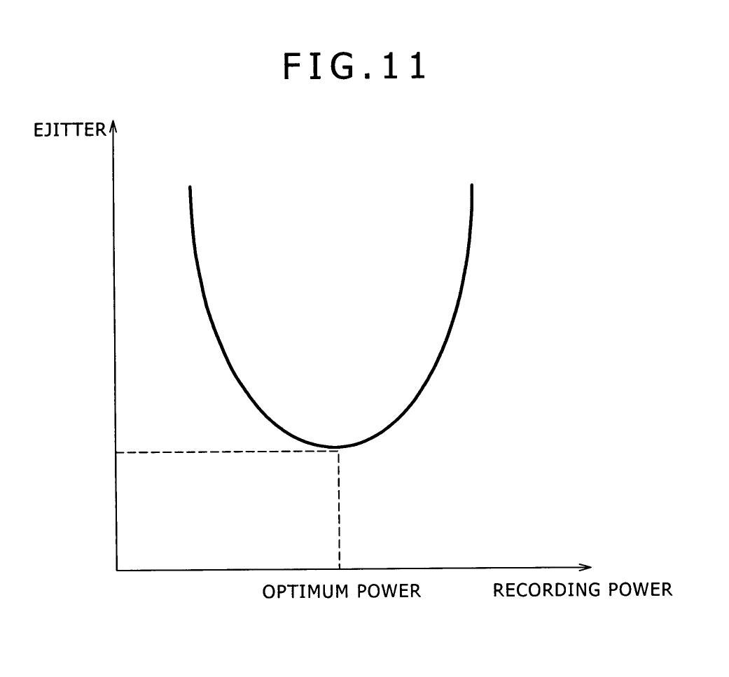

The E jitter values (EJitter or EJitter₀) acquired by the quality evaluation section 114 correspond to the diverse recording power levels on a one-to-one basis. For this reason, the recording power level in effect when the E jitter value (EJitter or EJitter₀) is the smallest is the optimum recording power level. FIG. 11 is a schematic view explanatory of how the recording power level at which the E jitter value (EJitter or EJitter₀) is the smallest is set as the optimum recording power.

The E jitter values (EJitter or EJitter₀) acquired and stored in the memory 131 are retrieved by the MCU 102 to search for the smallest value. The E jitter value (EJitter or EJitter₀) thus searched for and detected is set as the optimum recording power level in step S111.

The search for the smallest value may be accomplished in one of two ways. On the one hand, it is possible to search directly for the smallest of the E jitter values (EJitter or EJitter₀). On the other hand, the E jitter values (EJitter or EJitter₀) may be plotted alternatively to form a curve of approximations and the smallest value may be found from the curve.

The process above brings to an end the sequence of determining as the optimum recording power the recording power level at which the E jitter value (EJitter or EJitter₀) is the smallest. The recording power level thus determined is used to carry out actual data recording. In this manner, data can be recorded and reproduced at high quality levels with a minimum of jitters.

The information recording apparatus of the embodiment according to the present invention described above is an apparatus that records information to the optical disk 100. As shown in FIG. 9, the information recording apparatus is made up of a data recording section (recording power control section 104, etc.) that records data to the optical disk while changing the laser power level successively; a data reproduction section (PRML 113, etc.) that reproduces the data recorded by the data recording section; and an optimum recording power calculation section (quality evaluation section 114, MCU 102, etc.) that calculates an optimum recording laser power level by making quality evaluations of the reproduced signal generated by the data reproduction section. The data reproduction section carries out PRML (Partial Response Maximum Likelihood) reproduction processing. The optimum recording power calculation section finds an E error formed by the difference in a Euclidean distance squared between the most likely path metric value and the second most likely path metric value based on the PRML reproduction information created by the data reproduction section in order to calculate E jitter values representing deviations of the E error from a theoretical value E₀ of E error distribution, the optimum recording power calculation section further calculating as the optimum recording power a laser power level corresponding to the recorded data of which the E jitter value is the smallest.

The data recording section, as discussed above, changes the laser power level in random fashion, in gradually decreasing fashion, or in gradually increasing fashion. The optimum recording power calculation section calculates a plurality of E jitter values corresponding to the various laser power levels set by the data recording section, and determines as the optimum recording power the laser power level associated with the recorded data of which the calculated E jitter value is the smallest. The optimum recording power information thus calculated is stored into the memory.

The steps described above combine to determine as the optimum recording power the laser power level that brings about the smallest E jitter value (EJitter or EJitter₀). Actual data recording is performed using the recording power level thus determined, so that data can be recorded and reproduced at high quality levels with a minimum of jitters.

### [Other Variations of the Invention]

### Second Embodiment

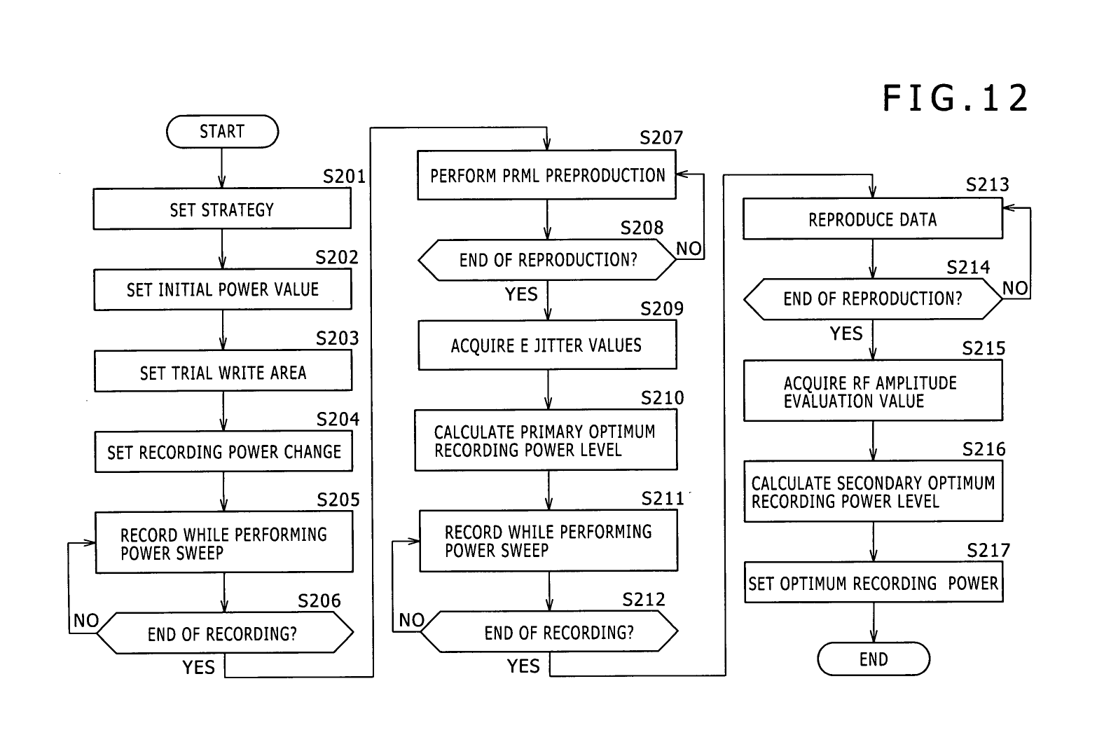

The optimum recording power setting sequence practiced as a second embodiment of the present invention will now be described below in reference to the flowchart of FIG. 12.

This optimum recording power setting sequence as the second embodiment of the invention involves calculating an optimum recording power level (i.e., primary optimum recording power level) using PRML-based evaluation values and, in reference to the recording power level thus calculated, determining another optimum recording power level (i.e., secondary optimum recording power level) in keeping with an evaluation index made up of the evaluation values derived from the RF amplitude values.

Steps S201 through S209 in the flowchart of FIG. 12 are the same as steps S101 through S109 in the flowchart of FIG. 8. In step S210 of the sequence as the second embodiment, an optimum recording power level is calculated using PRML-based evaluation values. The optimum recording power thus calculated is stored into the memory 131 (see FIG. 9) as the primary optimum recording power level.

In step S211, data is again recorded while the recording power level is changed successively. In this step, data is recorded after a range of power changes is set in reference to the primary optimum recording power level calculated in step S210. In step S212, a check is made to determine if the recording of data has ended. If the end of the recording is verified, then step S213 is reached and the data recorded while the recording power level was being changed is reproduced.

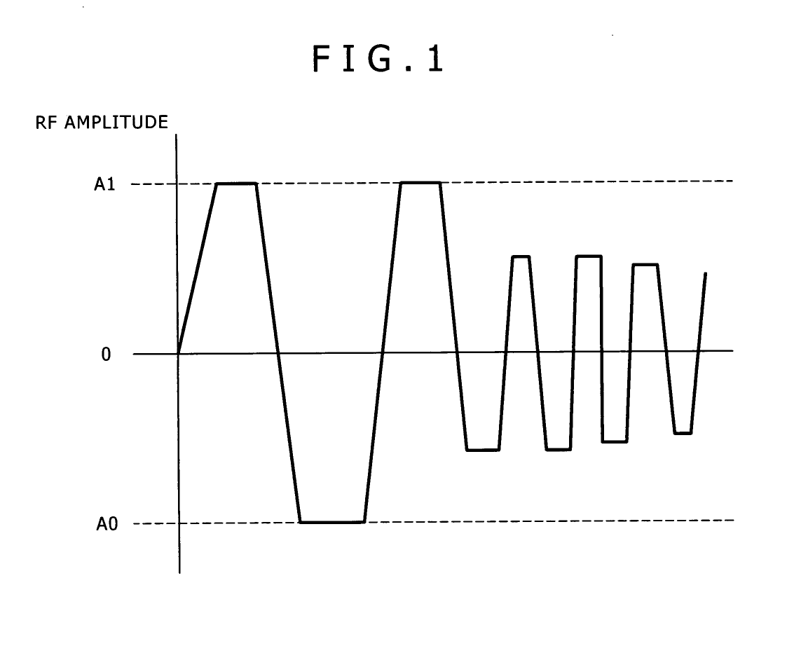

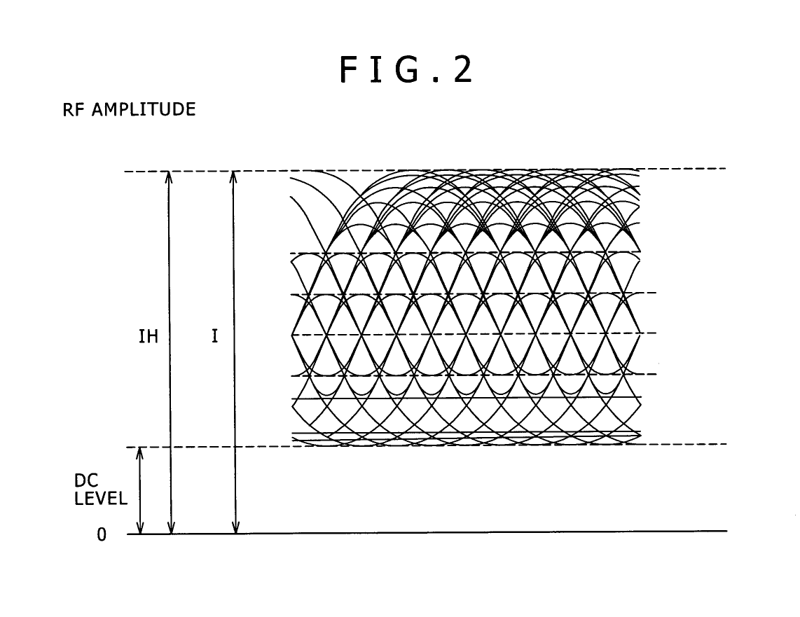

In step S214, a check is made to determine if the reproduction of the data has ended. If the end of the reproduction is verified, then step S215 is reached. In step S215, an evaluation value derived from the RF amplitude values based on the reproduced signal is acquired. Illustratively, the evaluation value explained above in reference to FIGS. 1 and 2 may be appropriated for step S215. In step S216, an optimum recording power level is calculated using as the evaluation index the evaluation value derived from the RF amplitude values in step S215. The optimum recording power level thus calculated is stored into the memory 131 (see FIG. 9) as the secondary optimum recording power level. These steps are carried out by an RF evaluation section 109 shown in FIG. 9.

In step S217, an ultimate optimum recording power level is determined. Illustratively, the ultimate optimum recording power level may be determined in one of two ways. One the one hand, it is possible to adopt the secondary optimum recording power level as the ultimate optimum recording power level. On the other hand, the ultimate optimum recording power level may be determined alternatively based both on the primary optimum recording power level calculated using the PRML-based evaluation value in step S210 and on the secondary optimum recording power level adopted using the RF evaluation value calculated in step S216. More specifically, the ultimate optimum recording power level may be set as an intermediate power level between the primary and the secondary optimum recording power levels. As another alternative, the primary and the secondary optimum recording power levels may be weighted by respectively predetermined amounts and the weighted values may be used as the basis for determining the ultimate optimum recording power level. These steps are carried out by the MCU 102 shown in FIG. 9.

As described, the optimum recording power setting sequence as the second embodiment of the invention combines the technique of using the E jitter value (Ejitter or EJitter₀) with the technique of utilizing the evaluation value derived from the RF amplitude values, in order to enhance the accuracy in calibrating the optimum recording power.

### Third Embodiment

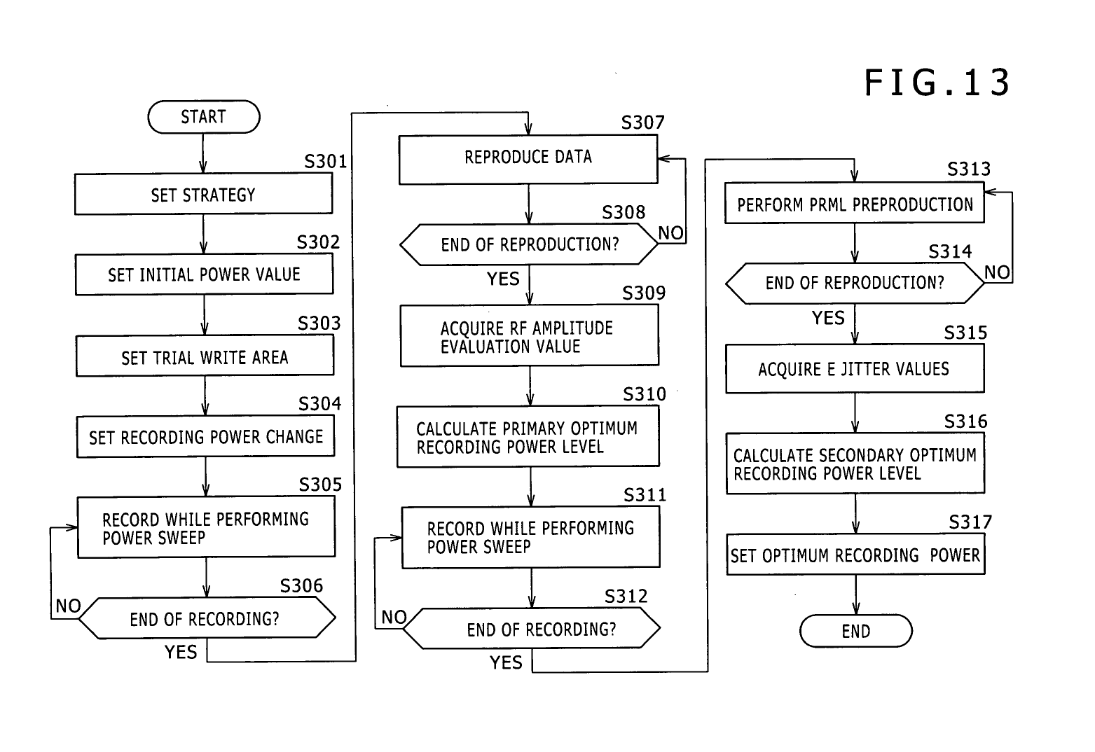

The optimum recording power setting sequence practiced as a third embodiment of the present invention will now be described below in reference to the flowchart of FIG. 13.

The optimum recording power setting sequence as the third embodiment of the invention involves calculating an optimum recording power level (i.e., primary optimum recording power level) in keeping with an evaluation index made up of the evaluation values derived from the RF amplitude values and, in reference to the recording power level thus calculated, determining another optimum recording power level (i.e., secondary optimum recording power level) using PRML-based evaluation values.

Steps S301 through S306 in the flowchart of FIG. 13 are the same as steps S101 through S106 in the flowchart of FIG. 8. In step S307 of the power setting sequence as the third embodiment, the data recorded while the recording power level was being changed is reproduced.

In step S308, a check is made to determine if the reproduction of the data has ended. If the end of the reproduction is verified, then step S309 is reached and the evaluation value is acquired from the RF amplitude values based on the reproduced signal. Illustratively, the evaluation value explained above in reference to FIGS. 1 and 2 may be appropriated for step S309. In step S310, an optimum recording power level is calculated using as the evaluation index the evaluation value derived from the RF amplitude values in step S309. The optimum recording power level thus calculated is stored into the memory 131 (see FIG. 9) as the primary optimum recording power level.

In step S311, data is again recorded while the recording power level is changed successively. In this step, data is recorded after a range of power changes is set in reference to the primary optimum recording power level calculated in step S310. In step S312, a check is made to determine if the recording of data has ended. If the end of the recording is verified, then step S313 is reached and PRML reproduction is made of the data recorded while the recording power level was being changed.

In step S314, a check is made to determine if the PRML reproduction has ended. If the end of the PRML reproduction is verified, then step S315 is reached. In step S315, the E jitter values (EJitter or EJitter₀) corresponding to the different recording power levels are calculated using the expression (2) or (3) explained above. The E jitter values (EJitter or EJitter₀) thus calculated are stored into the memory 131.

In step s316, another optimum recording power level is calculated by referencing the acquired E jitter values (EJitter or EJitter₀) corresponding to the diverse recording power levels. This step is carried out by the MCU (machine control unit) 102 shown in the block diagram of FIG. 9. The MCU 102 calculates the optimum recording power level (see FIG. 11) by referring to the E jitter values (EJitter or EJitter₀) corresponding to the various recording power levels and stored in the memory 131.

In step S317, an ultimate optimum recording power level is determined. Illustratively, the ultimate optimum recording power level may be determined in one of two ways. On the one hand, it is possible to adopt the secondary optimum recording power level as the ultimate optimum recording power level. On the other hand, the ultimate optimum recording power level may be determined alternatively based both on the primary optimum recording power level calculated using the RF evaluation value found in step S310 and on the secondary optimum recording power level computed using the PRML-based evaluation value in step S316. More specifically, the ultimate optimum recording power level may be set as an intermediate power level between the primary and the secondary optimum recording power levels. As another alternative, the primary and the secondary optimum recording power levels may be weighted by respectively predetermined amounts and the weighted values may be used as the basis for determining the ultimate optimum recording power level.

As described, the optimum recording power setting sequence as the third embodiment of the invention also combines the technique of using the E jitter value (EJitter or EJitter₀) with the technique of utilizing the evaluation value derived from the RF amplitude values, so as to enhance the accuracy in calibrating the optimum recording power.

### Fourth Embodiment

A fourth embodiment of the present invention involves controlling the optimum recording power in accordance with recording speed. This embodiment is devised in view of the high-speed recording scheme intended to shorten the time necessary for recording data to optical disks.

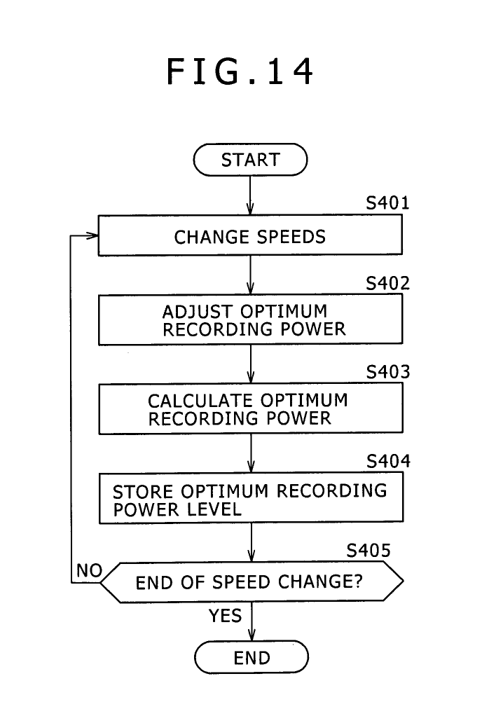

Varying recording speeds entail varying optimum recording power levels. That is, the recording power level may preferably be varied in keeping with the recording speed in effect. The flowchart of steps in FIG. 14 constitutes the optimum recording power setting sequence which, as the fourth embodiment of the present invention, causes an information recording apparatus having a variable-speed data recording section to change the level of recording power in accordance with different recording speed settings.

In step S401, the recording speed is changed. This step is carried out illustratively by the user who is about to record data at a desired speed. Specifically, the user may select one of a plurality of recordable speed settings preset on the system.

In steps S402 and S403, an optimum recording power level is adjusted and calculated. These steps are carried out in accordance with the recording speed set in step S401. That is, the optimum recording power level is calculated through the recording and evaluation processes according to the steps in the flowchart of FIG. 9, 12 or 13. During the above processing, data is recorded at the recording speed established in step S401.

In step S404, the optimum recording power level calculated in step S403 is stored into the memory 131. In step S405, a check is made to determine if the recording speed is changed anew. If a new recording speed is found to be set in step S405, then step S401 is reached again and the subsequent steps are repeated.

The steps described above are carried out every time a new recording speed is set on the system. The optimum recording power levels corresponding to different recording speed settings are calculated by the optimum recording power calculation section. The optimum recording power information associated with the diverse speed settings is stored into a library of the memory 131 illustratively in tabular form.

Thereafter, an optimum recording power level is retrieved from the memory whenever one of the speed settings is selected. Upon high-speed data recording, the optimum power level corresponding to the applicable recording speed is retrieved from the library of the memory. This arrangement eliminates the need for the time to calibrate optimum recording power halfway through recording so that the recording process is boosted in speed.

### Fifth Embodiment

Each of the foregoing embodiments was described as capable of calculating the optimum recording power level prior to the recording process and of recording data continuously at the calculated power level during actual data recording. With any one of these embodiments in use, however, the optimum recording power level calibrated at the beginning of the data recording process may not be sufficient for maintaining the quality of the recorded data.

The trouble may be attributed illustratively to two major factors. First, power characteristics may change over an extended period of laser irradiation. Secondly, the optimum recording power level can be varied due to changes in media characteristics. The irregularities may be circumvented by a fifth embodiment of the invention whereby the quality of data recording is maintained in the manner outlined below.

Data is first recorded at the optimum recording power level derived from the recording power control process, and the PRML evaluation value measured at that point is stored into the memory 131. During normal recording, the PRML evaluation value is measured and compared with the value obtained through recording power control and held in the memory. If the quality of data recording turns out to be worsening, the recording power control process is again carried out. The E jitter values (EJitter and EJitter₀) derived from the repeated recording power control process are compared with those acquired earlier and stored in the memory 131. The result of the comparison is used to determine whether the quality of data recording is appropriate. If the most recent measurements are not found to fall within a predetermined range of tolerances, then the recording power level needs to be calibrated again.

Alternatively, the PRML evaluation value may be calculated at predetermined time intervals. The results from these periodical evaluations may then be used to calibrate the optimum recording power level successively.

### [Evaluation of Quality in Data Recording]

As mentioned above, ordinary reproduction systems based on the binary slice level scheme have their TIA jitter value and bit error rate coincide theoretically with one another. This has made it possible to evaluate recording quality based on the TIA jitter value detected. However, with the above-described PRML reproduction setup applicable to high-density, mass-storage optical disk systems of the next generation, the TIA jitter values no longer constitute data directly corresponding to any evaluation values of recording quality.

In the typical PRML reproduction setup, it is possible to utilize, as the value suitable for recording quality evaluation, the E error value formed as the sum of the differences in the Euclidean distance squared between the most likely path metric value and the second most likely path metric value.

The series of the steps described above may be executed by hardware, by software, or by a combination of both. For the software-based processing to take place, the programs constituting processing sequences may be either loaded from dedicated hardware of a computer into its internal memory for execution, or installed at program execution time into a general-purpose computer or like equipment capable of executing diverse functions based on the installed programs. The programs may be recorded in advance on appropriate storage media for subsequent installation into the computer. Besides being installed from such storage media, the programs may also be received over network such as a LAN (local area network) and the Internet to be installed onto a suitable internal storage medium such as a hard disk drive of the computer.

The steps described in this specification represent not only the processes that are to be carried out in the depicted order (i.e., on a time series basis) but also processes that may be performed parallelly or individually as needed or depending on the performance of the apparatus used to execute the steps. In this specification, the term “system” refers to a logical configuration of a plurality of component devices. Each of the devices may or may not be housed in a single enclosure.

Where the present invention is embodied as described above, PRML (Partial Response Maximum Likelihood) reproduction is made of data having been recorded with the level of laser power changed successively. Based on PRML reproduction information created by the reproduction, an E error is found which is constituted by the difference in a Euclidean distance squared between the most likely path metric value and the second most likely path metric value in order to calculate E jitter values representing deviations of the E error from a theoretical value E₀ of E error distribution. Then optimum recording power is calculated in the form of a laser power level corresponding to the recorded data of which the E jitter value is the smallest. The invention thus makes it possible to determine the optimum recording power for acquiring the reproduced signal with a minimum of errors in compliance with the principle of PRML reproduction.

It is to be understood that while the invention has been described in conjunction with specific embodiments with reference to the accompanying drawings, it is evident that many alternatives, modifications and variations will become apparent to those skilled in the art in light of the foregoing description. Accordingly, it is intended that the present invention embrace all such alternatives, modifications and variations as fall within the spirit and scope of the appended claims.

What is claimed is:

1. An information recording apparatus for recording information to an optical disk, said information recording apparatus comprising:
a data recording section configured to record data to said optical disk while changing laser power levels successively;
a data reproduction section configured to reproduce the data recorded by said data recording section; and
an optimum recording power calculation section configured to calculate an optimum recording laser power level by evaluating the quality of a reproduced signal created by said data reproduction section, wherein
said data reproduction section performs data reproduction based on a partial response maximum likelihood procedure, and
based on partial response maximum likelihood reproduction information created by said data reproduction section, said optimum recording power calculation section finds an E error formed by the difference in a Euclidean distance squared between the most likely path metric value and the second most likely path metric value in order to calculate E jitter values representing deviations of said E error from a theoretical value E₀ of E error distribution, said optimum recording power calculation section further calculating as the optimum recording power a laser power level corresponding to the recorded data of which the E jitter value is the smallest.

2. The information recording apparatus according to claim 1, wherein
said data recording section changes the laser power levels in random fashion, in gradually decreasing fashion, or in gradually increasing fashion, and
said optimum recording power calculation section calculates a plurality of E jitter values corresponding to the laser power levels set by said data recording section in order to determine as said optimum recording power the laser power level corresponding to the recorded data of which the calculated E jitter value is the smallest.

3. The information recording apparatus according to claim 1, wherein
said data reproduction section performs partial response maximum likelihood reproduction of the data recorded by said data recording section and carries out data reproduction arranged to acquire a radio frequency signal, and
said optimum recording power calculation section performs reproduced signal evaluations based on said E jitter values as well as on said radio frequency signal to determine two items of evaluation information, before calculating said optimum recording power using the two evaluation information items thus determined.

4. The information recording apparatus according to claim 1, further comprising a memory configured to store the optimum recording power level calculated by said optimum recording power calculation section,
wherein said data recording section records data using said optimum recording power level stored in said memory.

5. The information recording apparatus according to claim 1, wherein
said data recording section changes recording speeds, and
said optimum recording power calculation section calculates optimum recording power levels corresponding to the recording speeds set by said data recording section.

6. The information recording apparatus according to claim 5, further comprising a memory configured to store the optimum recording power levels corresponding to the recording speeds calculated by said optimum recording power calculation section,
wherein, in accordance with the recording speed settings, said data recording section records data using any one of said optimum recording power levels stored in said memory.

7. An information processing method for causing an information recording apparatus which records information to an optical disk to calculate optimum recording power, said information processing method comprising the steps of:
recording data to said optical disk while changing laser power levels successively;
reproducing the data recorded in said data recording step; and
calculating an optimum recording laser power level by evaluating the quality of a reproduced signal created in said data reproducing step, wherein
said data reproducing step performs data reproduction based on a partial response maximum likelihood procedure, and
based on partial response maximum likelihood reproduction information created in said data reproducing step, said optimum recording power calculating step finds an E error formed by the difference in a Euclidean distance squared between the most likely path metric value and the second most likely path metric value in order to calculate E jitter values representing deviations of said E error from a theoretical value E₀ of E error distribution, said optimum recording power calculating step further calculating as the optimum recording power a laser power level corresponding to the recorded data of which the E jitter value is the smallest.

8. The information processing method according to claim 7, wherein
said data recording step changes the laser power levels in random fashion, in gradually decreasing fashion, or in gradually increasing fashion, and
said optimum recording power calculating step calculates a plurality of E jitter values corresponding to the laser power levels set in said data recording step in order to determine as said optimum recording power the laser power level corresponding to the recorded data of which the calculated E jitter value is the smallest.

9. The information processing method according to claim 7, wherein
said data reproducing step performs partial response maximum likelihood reproduction of the data recorded in said data recording step and carries out data reproduction arranged to acquire a radio frequency signal, and
said optimum recording power calculating step performs reproduced signal evaluations based on said E jitter values as well as on said radio frequency signal to determine two items of evaluation information, before calculating said optimum recording power using the two evaluation information items thus determined.

10. The information processing method according to claim 7, wherein said data recording step records to a memory the optimum recording power level calculated in said optimum recording power calculating step.

11. The information processing method according to claim 7, wherein
said data recording step changes recording speeds, and
said optimum recording power calculating step calculates optimum recording power levels corresponding to the recording speeds set in said data recording step.

12. The information processing method according to claim 11, wherein said optimum recording power calculating step records to a memory the calculated optimum recording power levels corresponding to the recording speed settings.

13. A computer program for causing an information recording apparatus which records information to an optical disk to calculate optimum recording power, said computer program comprising the steps of:
recording data to said optical disk while changing laser power levels successively;
reproducing the data recorded in said data recording step; and
calculating an optimum recording laser power level by evaluating the quality of a reproduced signal created in said data reproducing step, wherein
said data reproducing step performs data reproduction based on a partial response maximum likelihood procedure, and
based on partial response maximum likelihood reproduction information created in said data reproducing step, said optimum recording power calculating step finds an E error formed by the difference in a Euclidean distance squared between the most likely path metric value and the second most likely path metric value in order to calculate E jitter values representing deviations of said E error from a theoretical value E₀ of E error distribution, said optimum recording power calculating step further calculating as the optimum recording power a laser power level corresponding to the recorded data of which the E jitter value is the smallest.

14. An information recording apparatus for recording information to an optical disk, said information recording apparatus comprising:
data recording means for recording data to said optical disk while changing laser power levels successively;
data reproduction means for reproducing the data recorded by said data recording means; and
optimum recording power calculation means for calculating an optimum recording laser power level by evaluating the quality of a reproduced signal created by said data reproduction means, wherein
said data reproduction means performs data reproduction based on a partial response maximum likelihood procedure, and
based on partial response maximum likelihood reproduction information created by said data reproduction means, said optimum recording power calculation means finds an E error formed by the difference in a Euclidean distance squared between the most likely path metric value and the second most likely path metric value in order to calculate E jitter values representing deviations of said E error from a theoretical value E₀ of E error distribution, said optimum recording power calculation means further calculating as the optimum recording power a laser power level corresponding to the recorded data of which the E jitter value is the smallest.
